(19) United States
(12) Patent Application Publication
(10) Pub. No.: US 2012/0015618 A1
(43) Pub. Date: Jan. 19, 2012

(54) Method and Apparatus for Controlling Broadcast Receivers

(75) Inventors: Jani Heikkinen, Berlin (DE); Olaf Joeressen, Meerbusch (DE)

(73) Assignee: NOKIA CORPORATION, Espoo (FI)

(21) Appl. No.: 13/127,655

(22) PCT Filed: Nov. 4, 2008
(86) PCT No.: PCT/FI2008/000120

§ 371 Date: Sep. 27, 2011

(51) Int. Cl. H04B 1/06

(52) U.S. Cl. 455/230

(57) ABSTRACT

In accordance with an example embodiment of the present invention, an apparatus is described comprising a control interface, a detection unit configured to detect that an external broadcast receiver is coupled on the control interface, a control unit configured to select one of the external broadcast receiver and another broadcast receiver, and a user interface application configured to control the selected broadcast receiver.

### TECHNICAL FIELD

The present application relates generally to broadcast receivers and controlling broadcast receivers from a user interface.

### BACKGROUND

Apparatuses like mobile devices may comprise a broadcast receiver. The sound output from the broadcast receiver may be heard through a wired or wireless headset. The broadcast receiver is controlled by a user interface or user interface application on the apparatus.

Some types of wired or wireless accessories, for example headsets, comprise a broadcast receiver for audio and/or video. For example, a headset comprising an audio broadcast receiver may be used to listen to audio from a connected apparatus through a wired or wireless connection, or the headset may be used to listen to audio from the broadcast receiver.

Due to space, weight and/or cost restrictions on the wired or wireless headset, the headset may only comprise a simple user interface with few functions. For example, the headset may only comprise a volume key for adjusting the volume and a tune up/down key for changing the channel or frequency received by the broadcast receiver.

An accessory may be used with a number of apparatuses. For example, an accessory comprising a broadcast receiver may be used with an apparatus also comprising a broadcast receiver. Each accessory may use its own application to control the accessory. This may confuse a user, especially if the functionality of an accessory overlaps either with another accessory or with the apparatus.

### SUMMARY

Various aspects of examples of the invention are set out in the claims.

According to a first aspect of the present invention, an apparatus is described comprising a control interface, a detection unit configured to detect that an external broadcast receiver is coupled on the control interface, a control unit configured to select one of the external broadcast receiver and another broadcast receiver, and a user interface application configured to control the selected broadcast receiver.

According to a second aspect of the present invention, a method is disclosed comprising detecting that an external broadcast receiver is coupled on a control interface of an apparatus, selecting one of the external broadcast receiver and another broadcast receiver, detecting activation of a user interface application, and controlling the selected broadcast receiver by the user interface application.

According to a third aspect of the present invention a computer program, a computer-readable medium and a computer program product comprising a computer-readable medium are described comprising instructions to perform detecting that an external broadcast receiver is coupled on a control interface, selecting one of the external broadcast receiver and another broadcast receiver, detecting activation of a user interface application, and controlling the selected broadcast receiver by the user interface application.

According to a fourth aspect of the present invention an apparatus is disclosed comprising a control interface, a detection means configured to detect that an external broadcast receiving means is coupled on the control interface, a control means configured to select one of the external broadcast receiving means and another broadcast receiving means, a user interface application configured to control the selected broadcast receiving means.

### BRIEF DESCRIPTION OF THE DRAWINGS

For a more complete understanding of example embodiments of the present invention, reference is now made to the following descriptions taken in connection with the accompanying drawings in which:

FIG. 1 shows an apparatus according to an example embodiment of the invention in use with an accessory;

FIG. 2 shows an apparatus according to an example embodiment of the invention when no headset is connected;

FIG. 3 shows an apparatus according to an example embodiment of the invention in use with a wired headset;

FIG. 4 shows an apparatus according to an example embodiment of the invention in use with a wireless headset;

FIG. 5 shows an apparatus according to an example embodiment of the invention when a user interface application for control of a broadcast receiver is not active;

FIG. 6 shows an apparatus according to an example embodiment of the invention in use with a video accessory;

FIG. 7 shows control paths of an apparatus according to an example embodiment of the invention coupled to an accessory through a Bluetooth™ connection;

FIG. 8 shows control paths of an apparatus according to an example embodiment of the invention coupled to an accessory through a Bluetooth™ connection and to another accessory through a universal serial bus (USB) connection;

FIG. 9 shows a flow chart for controlling a broadcast receiver according to an example embodiment of the invention;

FIG. 10 shows a flow chart for controlling a broadcast receiver according to a further example embodiment of the invention; and

FIG. 11 shows a block diagram of an apparatus according to an example embodiment of the invention.

### DETAILED DESCRIPTION OF THE DRAWINGS

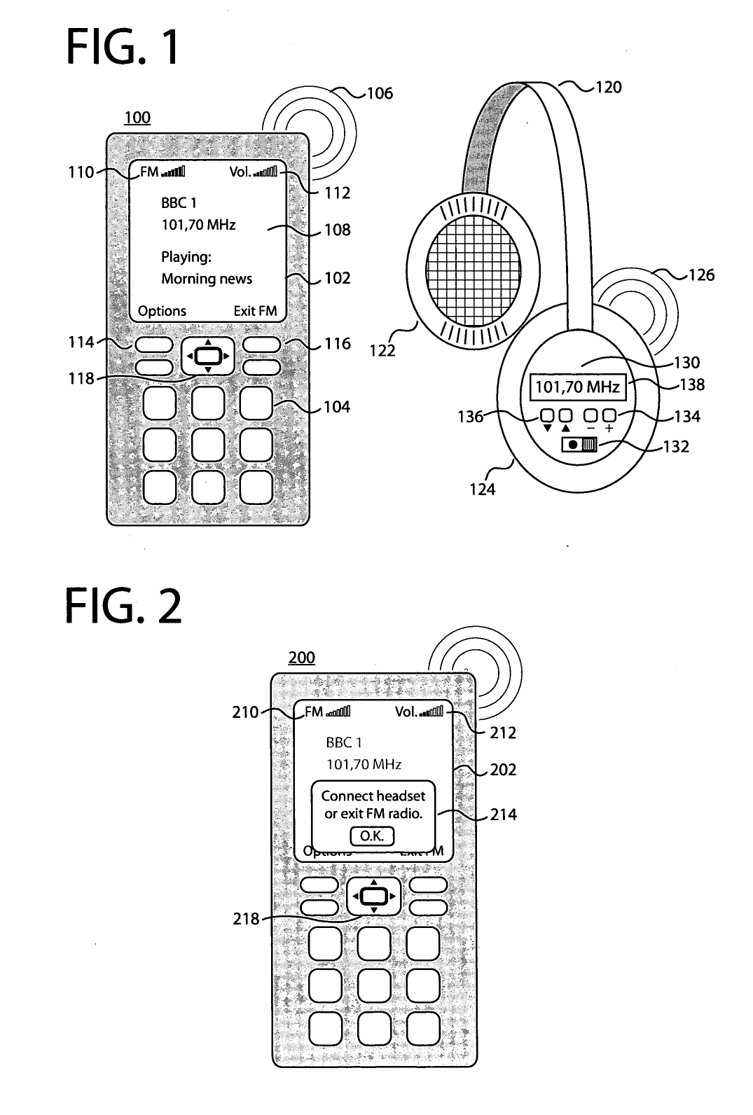

Example embodiments of the present invention and its potential advantages are best understood by referring to FIGS. 1 through 11 of the drawings.

In order to provide a user with the experience to listen to a broadcast transmission, many apparatuses, for example mobile devices, mobile phones, personal digital assistants (PDAs), and/or the like, may comprise a broadcast receiver. If a wireless or wired headset can be coupled through a wireless or wired control interface, the broadcast receiver may also be located in the headset.

The broadcast receiver may be an amplitude modulation (AM) or frequency modulation (FM) broadcast receiver. The broadcast receiver may be capable of receiving analog or digital broadcast transmission. The broadcast receiver may be capable of receiving audio transmissions. Further, the broadcast receiver may also be capable of receiving a transmission comprising video and audio data, for example a digital video broadcasting (DVB) transmission or a MediaFLO™ transmission. The broadcast receiver may further be able to receive data, for example electronic service guide (ESG) data or file transmissions. In an example embodiment, the broadcast receiver is a receiver capable of receiving broadcasts over the internet, for example so called “internet radio”. In an example embodiment, “internet radio” comprises streaming of audio data sent out from a broadcasting station.

A user may have several apparatuses and several accessories, for example wireless or wired headsets, some with a broadcast receiver and some without. An apparatus or a headset may have its own method to control the broadcast receiver, for example by a user interface (UI) application that is comprised in the software of the apparatus, or by a simple UI, for example on the headset.

The user may use different headsets on different occasions. For example, the user may prefer to use with an apparatus a wireless headset comprising a broadcast receiver, but he/she may occasionally use a wired headset not comprising a broadcast receiver, for example when the battery of the wireless headset is exhausted. If the apparatus comprises a broadcast receiver as well, the user may be able to continue listening to the broadcast that he/she previously listened to when the wireless headset was coupled and when the broadcast receiver in the wireless headset was used.

Thus, an apparatus having at least one or no broadcast receiver may be coupled to a wireless or wired headset having at least one or no broadcast receiver.

A wireless headset may comprise any kind of wireless bidirectional control interface. For example, it may comprise a Bluetooth™, an ultra-wideband (UWB), a wireless universal serial bus (wireless USB), a wireless local area network (W-LAN) or a WiFi™ interface as a wireless interface.

A wired headset may comprise a serial bidirectional wired control interface. For example, it may comprise a universal serial bus (USB) interface.

A wired or wireless headset may comprise a microphone.

A wired or wireless headset may comprise one or more buttons or switches for control purposes.

FIG. 1 shows an apparatus according to an example embodiment of the invention in use with an accessory, for example a wireless headset.

In an example embodiment, apparatus 100 has a user interface comprising a display 102 and a keypad 104. The display 102 may comprise a touch screen. Apparatus 100 comprises a wireless interface 106, for example a Bluetooth™ interface.

Apparatus 100 comprises a user interface (UI) application for control of a broadcast receiver, for example UI application 108. FIG. 1 shows the UI application 108 running on display 102 controlling a broadcast receiver, for example an FM radio receiver. The UI application for control of a broadcast receiver may comprise software that controls the FM radio receiver. The control of the FM radio receiver may respond to user input on a keyboard, for example on keyboard 104. Further, the UI application for control of a broadcast receiver may comprise software that displays information from the FM radio receiver on a display, for example on display 102.

Wireless headset 120 comprising earphones 122 and 124 is coupled to the apparatus 100 through the Bluetooth™ interface 126. Wireless headset 120 further comprises a broadcast receiver, for example an FM radio receiver, which may be operated through a user interface on earphone 124, for example user interface 130. The user interface 130 comprises a power switch 132, volume buttons 134 to increase or decrease the volume, tuning buttons 136 to tune the frequency of the FM radio receiver up or down and a display 138. Due to size or other constraints the functionality of the user interface may be limited. For example, the user interface of the wireless headset 120 may not have buttons to store or recall radio stations.

The FM radio receiver of the wireless headset 120 may be capable of receiving data according to the radio data system (RDS) or the radio broadcast data system (RBDS). RDS and RDBS supply additional data on the radio program and the broadcasting network. As the technology and functionality of the RDS and RBDS are similar, the term “RDS” will be used throughout this specification to refer to RBDS as well. RDS data may comprise the station name (for example BBC1 or JAM_FM) and radio text like the title and/or artist of the current song that is played. The user interface of the wireless headset 120 may comprise a display 138. Display 138 may show the tuned frequency, for example 101,70 MHz, or it may show the station name. However, display 138 may be too small to show the title and/or artist of the current song.

Wireless headset 120 may use the Bluetooth™ interface 126 to transmit tuning data to the apparatus 100. For example, wireless headset 120 may transmit the tuned frequency or channel number to apparatus 100. Wireless headset 120 may also transmit RDS data to apparatus 100. In an example embodiment, apparatus 100 shows the tuning information and parts of the RDS data on display 102. For example, display 102 shows that the FM radio receiver of the wireless headset 120 is tuned to the frequency 101,70 MHz and is currently playing the “morning news”. Apparatus 100 may also display the FM radio signal strength on broadcast signal strength indicator 110. When the FM radio receiver is tuned to a different frequency by pressing a tuning button 134 on the wireless headset 120, the information is transmitted through the Bluetooth™ interface to the apparatus 100, and the change is reflected on the display 102. Display 102 may show the new frequency, new RDS data, and the signal strength of the new frequency in broadcast signal strength indicator 110.

In an example embodiment, display 102 shows the volume on volume indicator 112. When the volume is changed by pressing a volume button 134 of the wireless headset 120, the information is transmitted through the Bluetooth™ interface to the apparatus 100, and the change is reflected in the volume indicator 112 on the display 102.

Apparatus 100 uses the Bluetooth™ interface to control the FM receiver of the wireless headset 120. The FM receiver of the wireless headset may be controlled by the UI application 108 for control of a broadcast receiver running on apparatus 100. Keypad 104 may comprise dedicated volume keys. For example the left and right keys of multicontroller key 118 may be used as dedicated volume keys. When the UI application for control of the broadcast receiver is running, the dedicated volume keys may be configured to control the volume of the FM receiver in the wireless headset 120 without using the volume buttons 134 on the wireless headset 120. When a key press of a dedicated volume key on apparatus 100 is detected, one or more volume control commands are transmitted on the Bluetooth™ interface to the wireless headset 120 to control the volume.

The wireless headset 120 may send back volume information on the Bluetooth™ interface, for example a new volume level.

Keypad 104 may use the up and down keys of multicontroller key 118 as tuning keys to tune the receive frequency. When the UI application for control of the broadcast receiver is running, the tuning keys may be configured to control the frequency of the FM receiver in the wireless headset 120 without using the tuning buttons 134 on the wireless headset 120. When a key press of a tuning key on apparatus 100 is detected, one or more tuning control commands are transmitted on the Bluetooth™ interface to the wireless headset 120 to tune the frequency. The wireless headset 120 may send back tuning information on the Bluetooth™ interface, for example a new frequency and the received signal strength of the new frequency.

In an example embodiment, keypad 104 of apparatus 100 may comprise soft keys 114 and 116. A label naming the functions of each soft key 114 and 116 is displayed at the bottom of display 102 above each soft key.

A label “Options” may be displayed above left soft key 114. When the left soft key 114 is pressed, an options menu may be displayed. The options menu may comprise further commands, for example to store and recall FM radio stations, mute the FM radio, run an “auto search” for FM radio stations, switch RDS data display on or off, change display brightness, or any other command that may be used in relation to the broadcast receiver or the UI application controlling the broadcast receiver. When a command related to the FM radio receiver is selected, a corresponding control command may be transmitted on the Bluetooth™ interface to the wireless headset 120. For example, an “auto search” command may be transmitted on the Bluetooth™ interface to the wireless headset 120, starting an automatic search and tuning procedure in the FM receiver of the wireless headset 120.

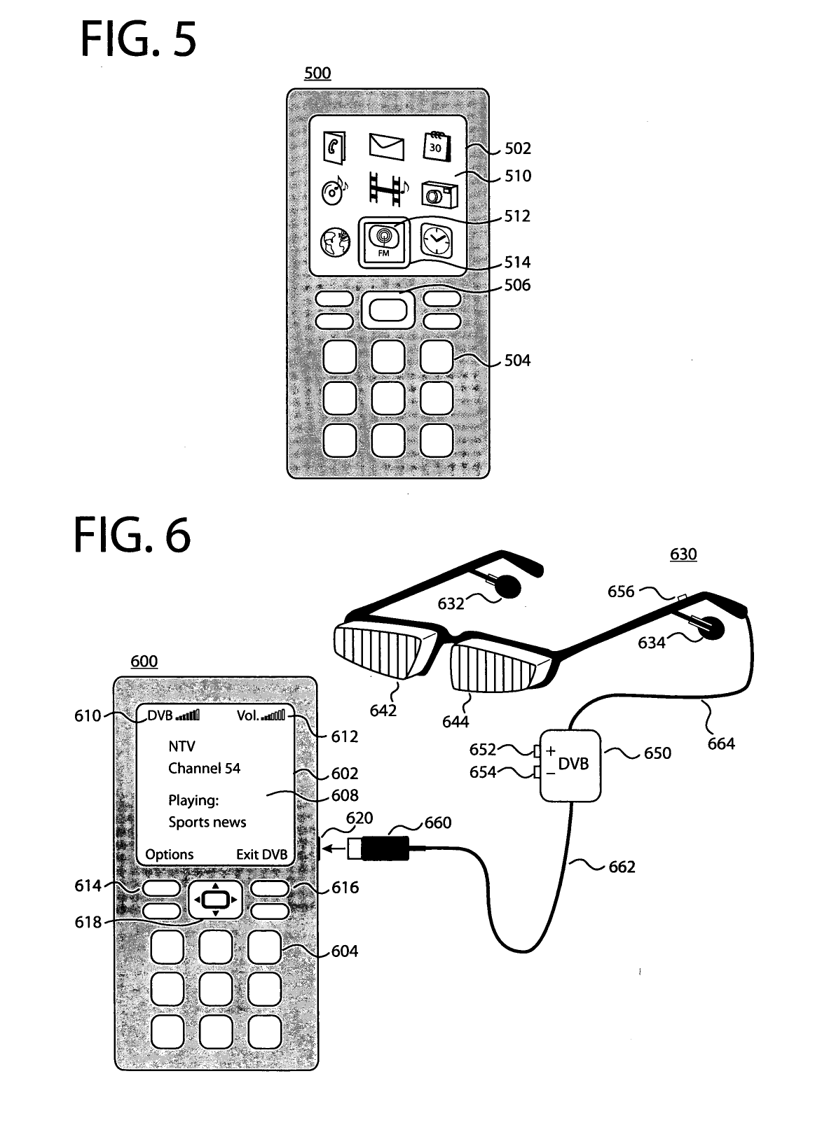

A label “Exit FM” may be displayed above the right soft key 116. When the right soft key 116 is pressed, the UI application for control of the broadcast receiver is terminated. After terminating the UI application for control of the broadcast receiver, display 102 may show a number of applications to select from, for example as shown in FIG. 5.

In an example embodiment, apparatus 100 comprises a broadcast receiver, for example an FM radio receiver. The FM radio receiver of apparatus 100 is not used in the scenario shown in FIG. 1, as the FM radio receiver of the wireless headset 120 is already running. The FM radio receiver of headset 120 may be preferred above the FM radio receiver of apparatus 100, as the FM radio receiver of headset 120 may provide a better audio quality, have a better signal processing to cope with a low FM radio signal strength, have a better antenna, or have a lower power consumption. For example, the wireless headset may have a built in antenna. Apparatus 100 may not have a built in antenna and may use the wire of a wired headset as FM radio antenna. Thus, when no wired headset is connected, it may not be possible to use the FM radio receiver of apparatus 100.

FIG. 2 shows an apparatus 200 according to an example embodiment of the invention when no headset is coupled.

In the example embodiment, a UI application for control of a broadcast receiver may only be used in apparatus 200 when a headset is connected. When the UI application for control of a broadcast receiver is started or launched without a headset being connected, or when the connection to a headset is interrupted or disconnected, a message box 214 appears asking the user to connect a headset or to exit the UI application for control of a broadcast receiver. The last used FM radio station name and frequency may appear in the background of display 202. The last used FM radio station name and frequency may appear in a faded color, as no reception is currently possible. FM radio signal strength indicator 210 may indicate that no signal is received. Volume indicator 212 may still show the set volume level. When a wired headset is connected, or when a connection to a wireless headset is established, the message box 214 disappears and reception of the last used FM radio station is restarted. When no headset is connected, a key press on the center key of multicontroller key 218 may confirm to exit the UI application for control of a broadcast receiver.

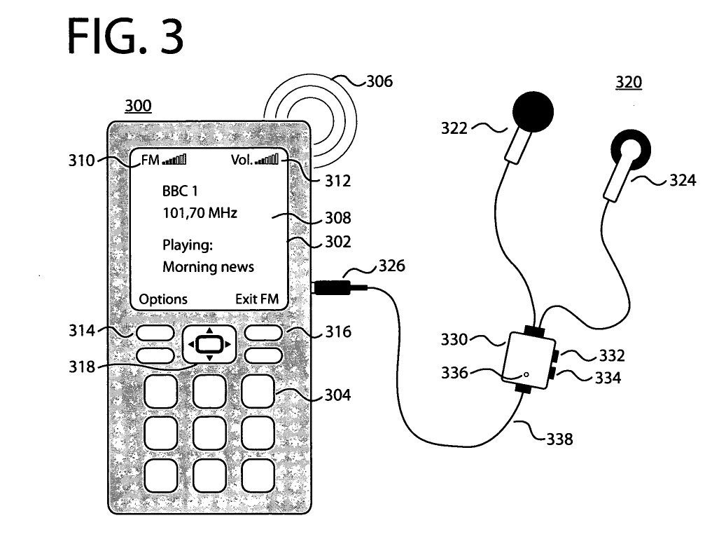

FIG. 3 shows an apparatus 300 according to an example embodiment of the invention in use with a wired headset 320.

Apparatus 300 is connected to a wired headset 320 through connector 326. Wired headset 320 comprises earphones 322 and 324. Wired headset 320 may also comprise a control unit 330. The control unit 330 may have buttons 332 and 334, for example to control the volume of the wired headset 320. The control unit 330 may also comprise a microphone 336. A wire in cable 338 may act as an antenna for a broadcast receiver.

In an example embodiment of the invention, apparatus 300 comprises a broadcast receiver, for example an FM radio receiver. Display 302 shows the UI application 308 for control of a broadcast receiver, for example an FM radio receiver. In an example embodiment, the same UI application for control of broadcast receiver controls the FM radio receiver of apparatus 300 that was described in relation to FIGS. 1 and 2.

The UI application 308 for control of a broadcast radio receiver shows the tuned FM radio frequency and the radio station name. The frequency and/or radio station may be the same that were set when apparatus 300 was used coupled to a wireless headset earlier, as shown in FIG. 1.

FM radio signal strength indicator 310 may show a signal strength that is different from the signal strength shown in the scenario of FIG. 1 in relation to wireless headset 120. This may be caused by different reception parameters, for example by the usage of a different antenna. Volume indicator 312 may show a volume level set by a user. Functions of some or all keys of keypad 304 may be the same as described in relation to keypad 104 of apparatus 100 in FIG. 1, as the function of one or more keys from keypad 304 may be controlled by the UI application for control of a broadcast receiver. For example, soft key 314 may be used to open an “Options” menu, soft key 316 may be used to exit the UI application for control of a broadcast receiver. Multicontroller key 318 may be used to change the volume or tune the FM receiver to a different frequency or station. Wireless interface 306 may be idle.

When apparatus 300 detects the presence of a wireless headset comprising an FM receiver on wireless interface 306, apparatus 300 may decide to set up a communication link to the wireless headset and return to the scenario of FIG. 1.

The UI application for control of a broadcast receiver may base the decision to use the FM radio receiver of the wireless headset or to continue using the FM radio receiver of apparatus 300 on user input, data stored in apparatus 300, data reported by the wireless headset and/or internal FM radio receiver, a comparison of reported and/or measured data, or any other criteria related to the usage of a broadcast receiver. The decision may be based on any single criterion or any combination of the above named criteria.

The decision to establish a connection to the wireless headset and use the FM receiver of the wireless headset may be based on a user input. For example a user query may appear on display 302 of apparatus 300: “Connect to wireless headset?” Soft keys 314 and 316 may be used to input “yes” or “no”, respectively.

The decision to use the FM receiver of the wireless headset may be based on data stored in apparatus 300. For example, a user preference may be stored in a memory of apparatus 300, instructing the UI application for control of a broadcast receiver to use the FM receiver of a wireless headset, when a coupling to a wireless headset comprising an FM radio receiver is possible. Thus, a user query can be avoided and a handover from the internal FM radio receiver to the FM radio receiver of the wireless headset can be initiated.

The decision to use the FM receiver of the wireless headset may be based on information reported by the wireless headset. In an example embodiment, the UI application 308 for control of a broadcast receiver may query the wireless headset through wireless interface 306 to measure an FM radio signal strength on the currently set frequency. The wireless headset may report the measured signal strength. The UI application for control of a broadcast receiver compares the measured signal strength of the wireless headset to a measured signal strength by the FM receiver of apparatus 300.

In an example embodiment, the UI application for control of a broadcast receiver may query the wireless headset through wireless interface 306 to report a battery level and/or power consumption of the broadcast receiver of the wireless headset. The wireless headset may report the data. The UI application for control of a broadcast receiver compares the reported data to some fixed thresholds or to a battery level of apparatus 300 and a power consumption of the FM receiver of apparatus 300.

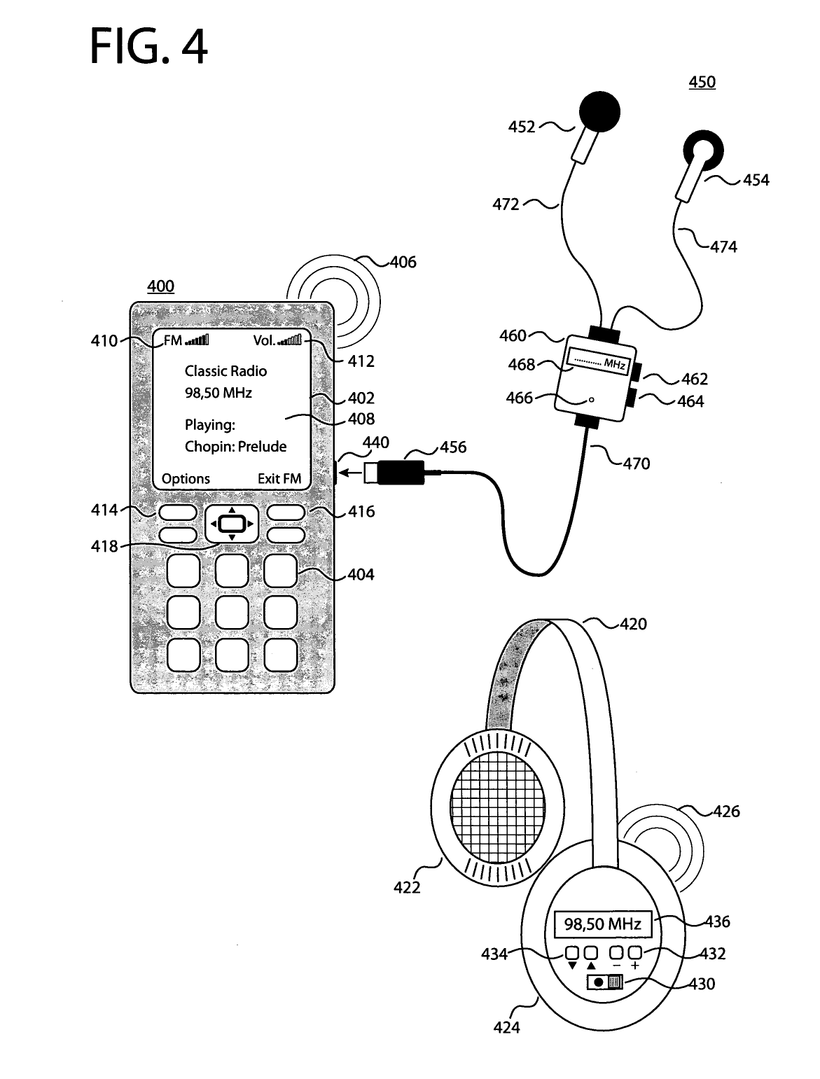

FIG. 4 shows an apparatus according to an example embodiment of the invention in use with a wireless headset. In the scenario of FIG. 4, a wired headset is about to be connected.

Apparatus 400 is coupled through a wireless interface 406 to wireless headset 420. The configuration may be similar to the one described in relation to FIG. 1. A UI application 408 for control of a broadcast receiver is shown on display 402 of apparatus 400. Wireless headset 420 comprises a broadcast receiver that is controlled by the UI application 408 for control of a broadcast receiver. Apparatus 400 may or may not comprise a broadcast receiver. Display 436 of the wireless headset 420 and display 402 of apparatus 400 may show information related to a received broadcast signal. For example, display 436 of the wireless headset 420 and display 402 of apparatus 400 may show the received frequency of the received broadcast signal. Further, apparatus 400 comprises a socket 440 for a serial digital interface.

In the example embodiment of FIG. 4, wired headset 450 also comprises a broadcast receiver. Wired headset 450 may comprise a serial digital interface and is configured to be coupled to apparatus 400 using connector 456. Connector 456 is suitable to connect to apparatus 400 through socket 440. In an example embodiment, power to wired headset 450 may be supplied through connector 456. Wired headset 450 may have a control unit 460 with a user interface comprising buttons 462, 464 and a display 468. Wired headset 450 may further comprise a microphone 466. In an example embodiment, cable 470 may comprise a wire for use as an antenna for the broadcast receiver in the wired headset 450. In an example embodiment, cable 472 and/or cable 474 may comprise one or more wires for use as an antenna for the broadcast receiver in the wired headset 450.

When the connector 456 of the wired headset 450 is connected to the socket 440 of apparatus 400, a data connection is made. Further, the wired headset 450 may be powered up upon connection to apparatus 400. Apparatus 400 detects the connection of wired headset 450. The UI application 408 for control of a broadcast receiver is notified that wired headset 450 comprises a broadcast receiver.

When the connection to the wired headset is detected, the apparatus 400 may decide to use the wired headset 450 and disconnect from wireless headset 420. The UI application 408 for control of a broadcast receiver may decide to use the broadcast receiver of the wired headset 450 instead of the broadcast receiver of the wireless headset 420.

The UI application for control of a broadcast receiver may base the decision to use the wired headset 450 or to continue using the wireless headset 420 on user input, data stored in apparatus 400, data reported by the wireless and/or wired headset, a comparison of reported and/or measured data, or any other criteria related to the usage of a broadcast receiver. The decision may be based on any single criterion or any combination of the above named criteria.

The decision to use the broadcast receiver of the wired headset may be based on a user input. For example a user query may appear on display 402 of apparatus 400: “Listen to FM radio on wired headset?” Soft keys 414 and 416 may be used to input “yes” or “no”, respectively.

The decision to use the broadcast receiver of the wired headset 450 or the wireless headset 420 may be based on data stored in apparatus 400. For example, a user preference may be stored in a memory of apparatus 400, instructing the UI application for control of a broadcast receiver to use the broadcast receiver of the wired headset, when the wired headset is coupled. Thus, a user query can be avoided and a handover from the broadcast receiver of the wireless headset to the broadcast receiver of the wired headset can be initiated.

The decision to use the broadcast receiver of the wired headset 450 or the wireless headset 420 may be based on information reported by the wired headset 450 and/or wireless headset 420. In an example embodiment, the UI application for control of a broadcast receiver may query the wired and/or the wireless headset through the wired interface and/or the wireless interface 406 to measure a broadcast signal strength on the currently set frequency. The wired headset 450 and/or the wireless headset 420 may report the measured signal strength(s). The UI application for control of a broadcast receiver then compares the measured signal strength of the wired headset 450 to a measured signal strength by the broadcast receiver of the wireless headset 420.

In an example embodiment, the UI application for control of a broadcast receiver may query the wired headset 450 through the wired interface to report a power consumption of the broadcast receiver of the wired headset 420. The wired headset 450 may report the data. Further, the UI application for control of a broadcast receiver may also query the wireless headset through wireless interface 406 to report a battery level and/or power consumption of the broadcast radio receiver of the wireless headset 420. The wireless headset 420 may report the data, and the UI application for control of a broadcast receiver then compares the reported data to one or more fixed thresholds. In an example embodiment, the UI application for control of a broadcast receiver may compare the reported battery level of the wireless headset 420 to a battery level of apparatus 400. In a further example embodiment, the UI application for control of a broadcast receiver may compare the reported power consumption of the wireless headset 420 to the reported power consumption of the broadcast receiver of wired headset 450.

In an example embodiment, apparatus 400 uses the wired interface to control the broadcast receiver of the wired headset 450. The broadcast receiver of the wired headset 450 may be controlled by the UI application 408 for control of a broadcast receiver. Input from keypad 404 may be used by the UI application to control the broadcast receiver of wired headset 450. For example the left and right keys of multicontroller key 418 may be used as dedicated volume keys. The dedicated volume keys may be configured to control the volume of the broadcast receiver in the wired headset 450 without using the volume buttons 462 or 464 on the wired headset 450. The UI application may use the up and down keys of multicontroller key 418 as tuning keys to tune the receive frequency. The tuning keys may be configured to control the frequency of the broadcast receiver in the wired headset 450 without using any tuning buttons on the wired headset 450. When a key press of a tuning key on apparatus 400 is detected, one or more tuning control commands are transmitted on the wired interface to the wired headset 450 to tune the frequency. The wired headset 450 may send back tuning information on the wired interface, for example a new frequency and the received signal strength of the new frequency.

In an example embodiment, the apparatus 400 comprises a broadcast receiver. Selecting a broadcast receiver for usage may be based at least in part on information related to the broadcast receiver of apparatus 400. Thus, selecting a broadcast receiver may comprise comparing data related to two or more broadcast receivers.

In an example embodiment, the process of selecting a broadcast receiver for usage is triggered by coupling or decoupling a device comprising a broadcast receiver, for example connecting an apparatus 400 to a wireless headset 420 or a wired headset 450. The process of selecting a broadcast receiver for usage may also be triggered by another criterion, for example a low battery warning of a device comprising a broadcast receiver. A low battery warning may be issued for example by apparatus 400 or by wireless headset 420. A low battery warning may be issued when the power level of the battery of a device crosses a threshold, for example a threshold of 10% of the full capacity of the battery.

In an example embodiment, the UI application for control of a broadcast receiver may store settings in a memory of apparatus 400. The memory may be a non-volatile memory, like a flash memory. Settings may comprise common settings. Common settings may be used independent of the selected broadcast receiver. Common settings may comprise a list of broadcasting stations, for example a list of preferred broadcasting stations, a current name and frequency of a broadcasting station, a current volume level that is set, preference settings for the selection of a broadcast receiver, and/or the like. When the UI application 408 for control of a broadcast receiver is started, or when a broadcast receiver is selected for usage, the common settings may be applied. Thus, these settings are made available to a user independent of the selected broadcast receiver.

In an example embodiment, the wireless interface 406 of the apparatus 400 and the wireless interface 426 of the wireless headset 420 is a Bluetooth™ interface. The Bluetooth™ interface may use vendor specific extensions of the “Human Interface Device” (HID) class. Suitable HID codes may be defined for broadcast radio use cases, for example setting/reading a frequency, setting mono/stereo blending type, setting/reading audio mode (mono/stereo), setting/reading a de-emphasis value, reading a signal strength of a tuned frequency, setting/reading a country dependent FM band, setting/reading an auto-search threshold (a level when auto-search is started), setting/reading a mute state, returning a found frequency of an auto-search, powering on/off of the broadcast receiver of the wireless headset 420, powering on/off RDS, reading a firmware version, reading an ASIC version, setting an RDS state, setting an RDS emergency warning system (EWS) state and the like. The apparatus 400 may send a “GET report” or “SET report” over the Bluetooth™ interface to wireless headset 420 in order to request information or send information. The wireless headset 420 may respond with an “OK”-message to acknowledge receipt of information, a “FAIL”-message to report that the “GET report” or “SET report” command has failed, or with a specific response including one or more requested values. The HID codes may also be used on other wireless or wired interfaces, for example on a USB interface.

It should be understood, that the embodiments described in relation to FIGS. 1 to 4 are merely illustrative, and therefore should not be taken to limit the scope of the invention. Further example embodiments of the invention may comprise an apparatus comprising a UI application for control of a broadcast receiver, independent of whether the apparatus comprises a broadcast receiver.

Example embodiments of an apparatus having a broadcast receiver may be used in scenarios of a wired headset comprising a broadcast receiver coupling or decoupling to the apparatus, or a wireless headset comprising a broadcast receiver coupling or decoupling to the apparatus.

Further, embodiments of an apparatus having no broadcast receiver and being coupled to a wireless headset comprising a broadcast receiver may be used in scenarios of a wired headset comprising a broadcast receiver connecting or disconnecting to the apparatus.

Further, embodiments of an apparatus having no broadcast receiver and being connected to a wired headset comprising a broadcast receiver may be used in scenarios of a wireless headset comprising a broadcast receiver coupling or decoupling to the apparatus.

FIG. 5 shows an apparatus according to an example embodiment of the invention when the UI application for control of a broadcast receiver is not active. Apparatus 500 may be a mobile apparatus, for example a mobile phone comprising a transceiver for a cellular system and a telephone application. The transceiver may be suitable for use in a Global System for Mobile communications (GSM), a code division multiple access (CDMA) system, for example a CDMA2000 system, a wideband CDMA system (W-CDMA), a third generation (3G) system, a Universal Mobile Telecommunications System (UMTS), a Long Term Evolution (LTE) system, or any other cellular system suitable for mobile communication. Mobile phone 500 has a user interface comprising a display 502 and a keypad 504 with a multicontroller key 506. The display 502 shows icons 510 arranged in a grid. Each icon may be related to an application that may be launched by a user input on keypad 504. In an example embodiment, an application may be launched by a voice command from a user. Display 502 may show icons related to a phonebook of the telephone application, a messaging application, a calendar application, a music player, a media gallery, a camera, a browser, a clock, and/or the like. Further, display 502 shows an icon 512 related to a UI application for control of a broadcast receiver, for example an FM radio receiver. Frame 514 highlights one of the icons for selection. Frame 514 may be shifted left, right, up or down by the multicontroller key 506. When the center key of multicontroller key 506 is pressed, the application related to the selected icon is launched. For example, when icon 512 is selected, the UI application for control of a broadcast receiver is launched upon a center key press on multicontroller key 506.

FIG. 6 shows an apparatus according to an example embodiment of the invention in use with a video accessory, for example a pair of video glasses comprising a DVB receiver.

In an example embodiment, apparatus 600 has a user interface comprising a display 602 and a keypad 604. Apparatus 600 may comprise a wireless or wired interface. In the example embodiment shown in FIG. 6, apparatus 600 comprises a USB interface providing connector 620.

Apparatus 600 comprises a user interface (UI) application for control of a broadcast receiver, for example for control of a DVB receiver. Apparatus 600 further comprises a DVB receiver. FIG. 6 shows the UI application 608 running on display 602. The UI application may show the name of the television (TV) program and the channel information. For example, display 602 shows that the DVB receiver is receiving a program named “NTV” on channel 54. The program is currently playing “Sports news”. The program name and further information may be extracted from electronic service guide (ESG) data of the DVB stream. Apparatus 600 may also display the DVB signal strength on indicator 610. Keypad 604 may use the up and down keys of multicontroller key 618 as channel selection keys or program selection keys. Display 602 may also show the video stream of the received TV program.

In an example embodiment, display 602 shows a volume level on indicator 612. Keypad 604 may comprise dedicated volume keys. For example the left and right keys of multicontroller key 618 may be used as dedicated volume keys. When the UI application for control of a broadcast receiver is running, the dedicated volume keys may be configured to control the volume of the DVB receiver.

A label “Options” may be displayed above left soft key 614. When the left soft key 114 is pressed, an options menu may be displayed. The options menu may comprise further commands, for example to store and recall TV stations received by the DVB receiver, mute the DVB audio, run an “auto search” for DVB channels, change display brightness and/or contrast, or any other command that may be used in relation to the DVB receiver or the UI application controlling the broadcast receiver.

A label “Exit DVB” may be displayed above the right soft key 616. When the right soft key 616 is pressed, the UI application for control of a broadcast receiver is terminated. After terminating the UI application for control of a broadcast receiver, display 602 may show a number of applications to select from, for example applications as shown in FIG. 5.

Wired video glasses 630 comprising earphones 632 and 634 and video projection units 642 and 644 are configured to be connected to the apparatus 600 through the USB interface by USB plug 660. Wired video glasses 630 further comprise a DVB receiver 650. DVB receiver 650 may reside in a box connected to the video glasses by cable 664, or it may be integrated in a part of the glasses, for example in one of the earpieces. DVB receiver 650 may be connected to USB plug 660 by cable 662. Cable 662 and/or cable 664 may further comprise parts of an antenna for DVB receiver 650. DVB receiver 650 may comprise a simple user interface. The user interface may comprise switches, for example volume buttons 652 and 654. The user interface may also comprise buttons at the glasses, like button 656. Due to size or other constraints the functionality of the user interface may be limited.

When the USB plug 660 of the wired video glasses 630 is connected to the USB connector 620 of apparatus 600, the wired video glasses 630 are powered up. Apparatus 600 detects the connection of wired video glasses 630. The UI application for control of a broadcast receiver is notified that wired video glasses 630 comprise a DVB receiver.

When the connection to the wired headset is detected, the UI application for control of a broadcast receiver may decide to use to DVB receiver 650 of the wired video glasses 630 and stop using the DVB receiver of apparatus 600.

The UI application for control of a broadcast receiver may base the decision to use the DVB receiver 650 of the wired video glasses 630 or to continue using the DVB receiver of apparatus 600 on user input, data stored in apparatus 600, data reported by the wired video glasses, a comparison of reported and/or measured data, or any other criteria related to the usage of a DVB receiver. The decision may be based on any single criterion or any combination of the above named criteria.

The decision to use the DVB receiver of the wired video glasses may be based on a user input. For example a user query may appear on display 602 of apparatus 600: “Continue watching NTV on video glasses?” Soft keys 614 and 616 may be used to input “yes” or “no”, respectively.

The decision to use the DVB receiver of the video glasses 630 or the DVB receiver of apparatus 600 may be based on data stored in apparatus 600. For example, a user preference may be stored in a memory of apparatus 600, instructing the UI application for control of a broadcast receiver to use the DVB receiver of the video glasses 630, when the video glasses are connected. Thus, a user query can be avoided and a handover from the DVB receiver of apparatus 600 to the DVB receiver of the wired video glasses 630 can be initiated.

The decision to use the DVB receiver of the wired video glasses 630 or the DVB receiver of apparatus 600 may be based on information reported by the wired video glasses 630 and/or the DVB receiver of apparatus 600. In an example embodiment, the UI application for control of a broadcast receiver may query the DVB receiver of the wired video glasses 630 through the USB interface and/or the DVB receiver of apparatus 600 to measure a broadcast signal strength on the currently set frequency. The DVB receiver of the wired video glasses 630 and the DVB receiver of apparatus 600 may report the measured signal strengths. The UI application for control of a broadcast receiver then compares the measured signal strength of the wired video glasses 630 to the reported measured signal strength by the DVB receiver of apparatus 600.

In an example embodiment, the UI application for control of a broadcast receiver may query the wired video glasses 630 through the USB interface to report a power consumption of the DVB receiver of the wired video glasses 630. The wired video glasses 630 may report the data. Further, the UI application for control of a broadcast receiver may also query apparatus 600 to report a battery level and/or power consumption of the broadcast radio receiver of apparatus 600. Apparatus 600 may report the data, and the UI application for control of a broadcast receiver then compares the reported data to one or more fixed thresholds. In an example embodiment, the UI application for control of a broadcast receiver may compare the reported battery level of the wired video glasses 630 to a battery level of apparatus 600. In a further example embodiment, the UI application for control of a broadcast receiver may compare the reported power consumption of the wired video glasses 630 to the reported power consumption of the broadcast receiver of apparatus 600.

In an example embodiment, apparatus 600 uses the USB interface to control the DVB receiver 650 of the wired video glasses 630. The DVB receiver of the wired video glasses may be controlled by the UI application 608 for control of a broadcast receiver running on apparatus 600. Input from keypad 604 may be used by the UI application for control of a broadcast receiver to control the DVB receiver of wired video glasses 630. For example the left and right keys of multicontroller key 618 may be used as dedicated volume keys. The dedicated volume keys may be configured to control the volume of the DVB receiver 650 in the wired video glasses without using the volume buttons 652 and 654 on the wired video glasses 630. The UI application for control of a broadcast receiver may use the up and down keys of multicontroller key 618 as channel selection keys or program selection keys. In an example embodiment, number keys of keypad 604 may be used as channel selection keys or program selection keys. When a key press of a channel selection key or a program selection key on apparatus 600 is detected, one or more channel selection commands are transmitted on the USB interface to the wired video glasses 630 to select a channel. The wired video glasses may send back a tuning confirmation message on the USB interface that the channel was selected. The tuning confirmation message may comprise a received signal strength of the selected channel.

In an example embodiment, the UI application for control of a broadcast receiver may store settings in a memory of apparatus 600. The storage may be a non-volatile memory, like a flash memory. Settings may comprise common settings. Common settings may be used independent of the selected broadcast receiver. Common settings may comprise a list of TV (television) stations, for example a list of preferred TV stations, a current name and frequency of a TV station, a current volume level that is set, or preference settings for the selection of a television receiver. When the UI application for control of a DVB receiver is started, or when a broadcast receiver is selected for usage, the common settings may be applied. Thus, these settings are made available to a user independent of the selected broadcast receiver.

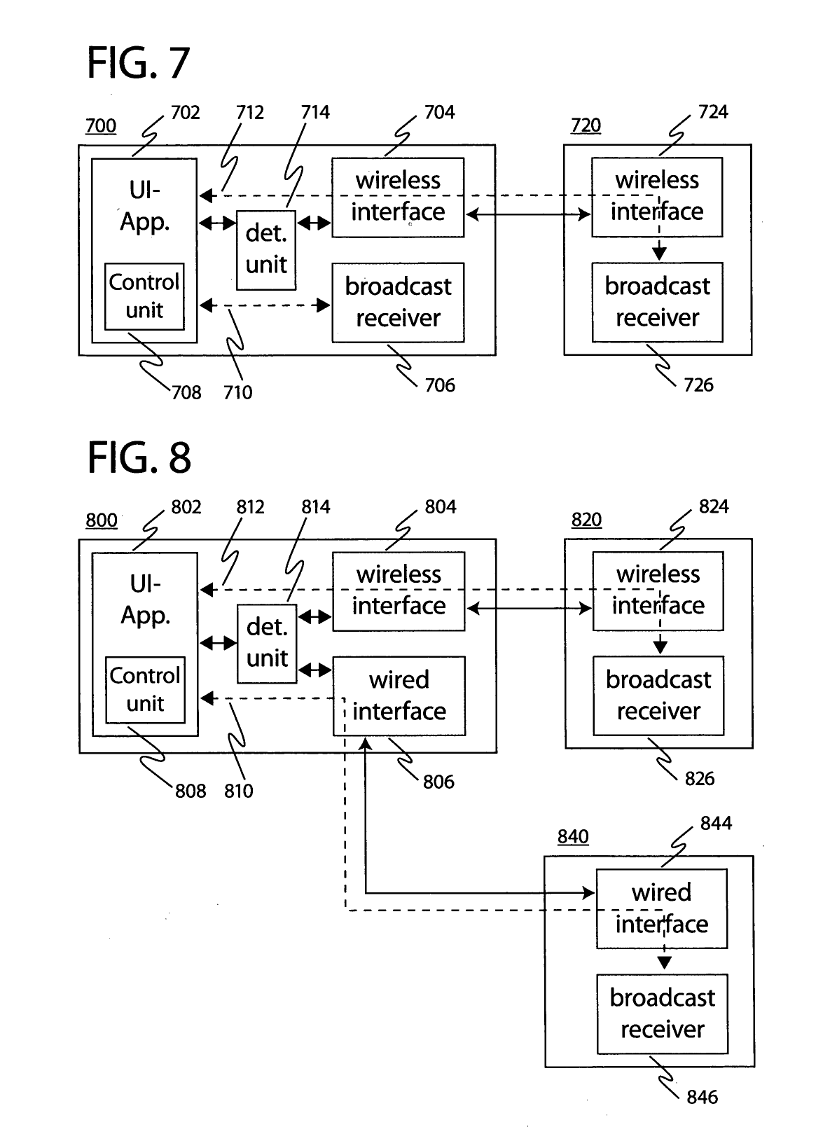

FIG. 7 shows control paths of an apparatus according to an example embodiment of the invention coupled to an accessory through a wireless control interface. Apparatus 700 comprises a UI application for control of a broadcast receiver 702, a wireless transceiver 704, for example a Bluetooth™ transceiver, and a broadcast receive 706. A detection unit 714 informs the UI application for control of a broadcast receiver 702 when an accessory 720 is coupled through the wireless interface 704. It may further inform the UI application for control of a broadcast receiver 702 about the capabilities of accessory 720. The UI application for control of a broadcast receiver 702 is configured to control broadcast receiver 706 as shown by dashed line 710.

In the example embodiment of FIG. 7, accessory 720 comprises a wireless transceiver 724 and a broadcast receiver 726. Apparatus 700 is coupled to accessory 720 through a wireless control interface. The UI application for control of a broadcast receiver 702 is further configured to control the broadcast receiver 726 of accessory 720 as shown by dashed line 712. Control information to and from the broadcast receiver 726 of accessory 720 is sent and received through the wireless control interface set up by the wireless transceiver 704 of apparatus 700 and the wireless transceiver 724 of accessory 720. Control unit 708 of apparatus 700 may be configured to select either broadcast receiver 726 in accessory 720 or broadcast receiver 706 in apparatus 700. Control unit 708 may be part of the UI application for control of a broadcast receiver 702.

In an example embodiment, broadcast receiver 706 is a receiver for receiving broadcast data from the internet. Thus, broadcasting content may be received on a connection to the internet. The connection to the internet may be set up using a WLAN connection or a connection to a cellular network, for example a CDMA connection or a UMTS connection. Thus, internet radio is controlled by the UI application for control of a broadcast receiver. An internet browser may not be used to control the internet radio in this embodiment.

FIG. 8 shows control paths of an apparatus according to an example embodiment of the invention coupled to an accessory through a wireless control interface, for example a Bluetooth™ connection, and to another accessory through a wired control interface, for example a USB connection. Apparatus 800 comprises a UI application for control of a broadcast receiver 802, a wireless transceiver 804 and a wired transceiver 806. A detection unit 814 informs the UI application for control of a broadcast receiver 7802 when an accessory 820 or 840 is coupled through the wireless interface 804 and/or the wired interface 806. It may further inform the UI application for control of a broadcast receiver 802 about the capabilities of accessory 820 and/or accessory 840.

In the example embodiment of FIG. 8, accessory 820 comprises a wireless transceiver 824 and a broadcast receiver 826. Apparatus 800 is coupled to accessory 820 through a wireless connection. The UI application for control of a broadcast receiver 802 is configured to control the broadcast receiver 826 of accessory 820 as shown by dashed line 812. Information to and from the broadcast receiver 826 of accessory 820 is sent and received through the wireless control interface set up by the wireless transceiver 804 of apparatus 800 and the wireless transceiver 824 of accessory 820.

Another accessory 840 comprises a wired transceiver 844 and a broadcast receiver 846. Apparatus 800 is connected to accessory 840 through a wired connection. The UI application for control of a broadcast receiver 802 is further configured to control the broadcast receiver 846 of the other accessory 840 as shown by dashed line 810. Information to and from the broadcast receiver 846 of the other accessory 840 is sent and received through the wired control interface set up by the wired transceiver 806 of apparatus 800 and the wired transceiver 844 of the other accessory 840. Control unit 808 of apparatus 800 may be configured to select either broadcast receiver 826 in accessory 820 for usage or broadcast receiver 846 in the other accessory 840. Control unit 808 may be part of the UI application for control of a broadcast receiver 802.

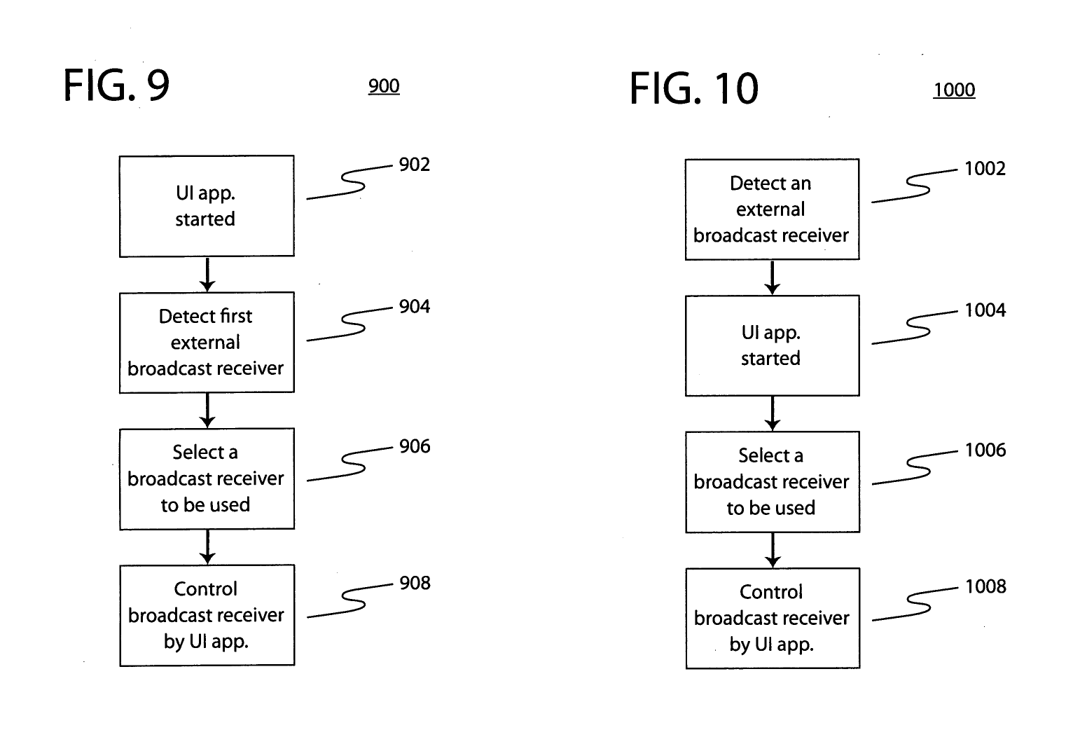

FIG. 9 shows a flow chart for controlling a broadcast receiver according to an example embodiment of the invention. At block 902 a UI application for control of a broadcast receiver is started. The UI application for control of a broadcast receiver may control a broadcast receiver built into an apparatus, for example broadcast receiver 706 of FIG. 7. At block 904, a first external broadcast receiver is detected, for example by a detection unit. In an example embodiment, an accessory 720 is detected through a wireless control interface, for example a Bluetooth™ interface, and it is further detected that the accessory 720 comprises a broadcast receiver 726. At block 906, a broadcast receiver is selected to be used, for example broadcast receiver 706 or broadcast receiver 726 of accessory 720. At block 908, the selected broadcast receiver is controlled by the UI application.

FIG. 10 shows a flow chart for controlling a broadcast receiver according to a further example embodiment of the invention. At block 1002, an external broadcast receiver is detected. For example in the embodiment of FIG. 8, while wireless accessory 820 comprising a broadcast receiver 826 may already be coupled, a further accessory 840 is detected by a detection unit (not shown) through a wired control interface, for example a USB interface, and it is further detected that the accessory 840 comprises another broadcast receiver 846. At block 1004 a UI application for control of a broadcast receiver is started. At block 1006, a broadcast receiver is selected to be used, for example broadcast receiver 826 of Bluetooth™ accessory 820 or broadcast receiver 846 of USB accessory 840. At block 1008, the selected broadcast receiver is controlled by the UI application.

In an example embodiment, an audio path is controlled from the selected broadcast receiver to an audio output. For example, an audio path to a connected headset may be controlled. Thus, audio output from the selected broadcast receiver is routed to the connected headset. Audio output from the selected broadcast receiver may not necessarily be routed through the apparatus comprising the UI application for control of a broadcast receiver. For example, if the connected headset comprises a broadcast receiver, and if the broadcast receiver of the headset is selected by the UI application for control of a broadcast receiver, the audio output may be routed within the headset to the earphones of the headset.

Further variations of the methods described in relation to FIGS. 9 and 10 are possible. In an example embodiment, a control unit for selection of a broadcast receiver is not part of the UI application for control of a broadcast receiver. Thus, the order of blocks 1004 and 1006 of FIG. 10 may be exchanged. In the example embodiment, the UI application for control of a broadcast receiver may initially not be running. An external broadcast receiver is detected at an apparatus comprising a broadcast receiver. A broadcast receiver to be used is selected. Then, the UI application for control of a broadcast receiver is started. The control unit tells the UI application which broadcast receiver to use, and the UI application controls the notified broadcast receiver.

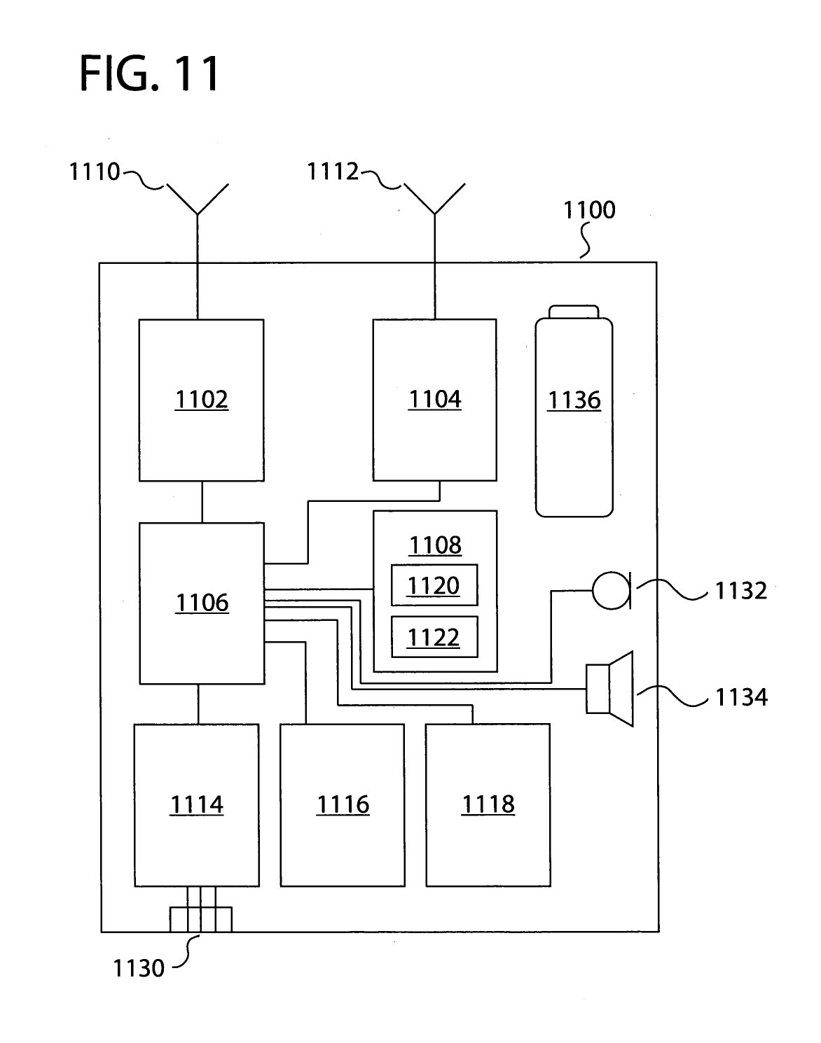

FIG. 11 shows an apparatus according to an example embodiment of the invention. Apparatus 1100 comprises a wireless interface 1102 which is controlled by a controller 1106. Wireless interface 1102 may be connected to an antenna 1110. Apparatus 1100 further comprises a broadcast receiver 1104. Broadcast receiver 1104 may be connected or connectable to antenna 1112. For example, a wired headset may comprise a wire which acts as antenna 1112 when the wired headset is connected. Apparatus 1100 further comprises a wired interface 1114. Wired interface 1114 may be accessed through connector 1130. Apparatus 1100 further comprises a user interface comprising keypad 1116, display 1118, microphone 1132, and loudspeaker 1134. Display 1118 may comprise a touch screen. Controller 1106 controls the wireless interface 1102, broadcast receiver 1104, wired interface 1114, keypad 1116, display 1118, microphone 1132 and loudspeaker 1134. Apparatus 1100 comprises a memory 1108, for example a Flash memory. Memory 1108 may be configured to store a computer program comprising computer program instructions in area 1120. The computer program may comprise a number of applications. The computer program comprises at least a UI application for control of a broadcast receiver, for example broadcast receiver 1104 or an external broadcast receiver coupled through wireless interface 1102 or through wired interface 1114. Memory 1108 may be configured to store common settings in area 1122. Common settings may be settings that are applied to a selected broadcast receiver, like broadcast receiver 1104, or an external broadcast receiver. Apparatus 1100 comprises a battery 1136. Common settings may comprise user preferences.

Without in any way limiting the scope, interpretation, or application of the claims appearing below, it is possible that a technical effect of one or more of the example embodiments disclosed herein may be that one or more broadcast receivers are controlled by a single UI application. Another possible technical effect of one or more of the example embodiments disclosed herein may be that settings stored for one broadcast receiver are also applied to another broadcast receiver. Another technical effect of one or more of the example embodiments disclosed herein may be that a handover from one broadcast receiver to another broadcast receiver is executed under control of a single UI application, for example when the other broadcast receiver having better performance parameters is coupled or when the energy supply for the broadcast receiver is exhausted.

Embodiments of the present invention may be implemented in software, hardware, application logic or a combination of software, hardware and application logic. The software, application logic and/or hardware may reside on a micro-processor, a digital signal processor or in application specific hardware. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus comprising:
a control interface;
a detection unit configured to detect that an external broadcast receiver is coupled on the control interface;
a control unit configured to select one of the external broadcast receiver and another broadcast receiver; and
a user interface application configured to control the selected broadcast receiver.

2. The apparatus of claim 1, wherein the control interface comprises a wireless interface.

3. (canceled)

4. The apparatus of claim 1, wherein the control interface comprises a wired interface.

5. (canceled)

6. The apparatus of claim 1, wherein the apparatus comprises the another broadcast receiver.

7. The apparatus of claim 6, comprising:
another control interface, and wherein the detection unit is further configured to detect that another external broadcast receiver is coupled on the another control interface.

8. The apparatus of claim 1, wherein the another broadcast receiver is another external broadcast receiver,
and wherein the apparatus comprises another control interface,
and wherein the detection unit is further configured to detect that the another external broadcast receiver is coupled on the another control interface.

9. The apparatus of claim 8, wherein the another control interface comprises a wired interface.

10. (canceled)

11. The apparatus of claim 1, further comprising a memory configured to store common settings of the external broadcast receiver and the another broadcast receiver,
a processor configured to apply the common settings to the selected broadcast receiver upon activation of the user interface application.

13. A method comprising:
detecting that an external broadcast receiver is coupled on a control interface of an apparatus;
selecting one of the external broadcast receiver and another broadcast receiver;
detecting activation of a user interface application; and
controlling the selected broadcast receiver by the user interface application.

14. The method of claim 13, wherein the control interface comprises a wireless interface.

15. The method of claim 14, wherein the wireless interface comprises a Bluetooth™ interface.

16. The method of claim 13, wherein the control interface comprises a wired interface with a universal serial bus interface.

17-18. (canceled)

19. The method of claim 13, comprising:
detecting that another external broadcast receiver is coupled on another control interface.

20. The method of claim 13, wherein the another broadcast receiver is another external broadcast receiver, further comprising:
detecting that the another external broadcast receiver is coupled on another control interface.

21. The method of claim 20, wherein the another control interface comprises a wired interface wherein the wired interface comprises a universal serial bus interface.

22. (canceled)

23. The method claim 9, comprising:
storing common settings of the external broadcast receiver and the another broadcast receiver.

24. The method of claim 16, wherein the common settings are applied to the selected broadcast receiver upon activation of the user interface application.

25. A computer program comprising instructions to perform:
detecting that an external broadcast receiver is coupled on a control interface;
selecting one of the external broadcast receiver and another broadcast receiver;
detecting activation of a user interface application; and
controlling the selected broadcast receiver by the user interface application.

26. A computer program product comprising a computer-readable medium bearing computer program code embodied therein for use with a computer, wherein the computer program code comprises the computer program of claim 25.

27. An apparatus comprising:
a control interface;
a detection means configured to detect that an external broadcast receiving means is coupled on the control interface;
a control means configured to select one of the external broadcast receiving means and another broadcast receiving means; and
a user interface application configured to control the selected broadcast receiving means.
